(19) United States
(12) Patent Application Publication
(10) Pub. No.: US 2004/0077399 A1
(43) Pub. Date: Apr. 22, 2004

(54) Apparatus and method for a tabletop bingo card monitor

(76) Inventor: Josiah F. Marshall, Irving, TX (US)

Correspondence Address: HUGHES & LUCE LLP, 1717 MAIN STREET, SUITE 2800, DALLAS, TX, 75201, US

(21) Appl. No.: 10/272,068

(22) Filed: Oct. 16, 2002

(51) Int. Cl. G06F 19/00

(52) U.S. Cl. 463/19

(57) ABSTRACT

An apparatus and method are described for monitoring bingo cards using a computer and a keyboard communicating via a wireless communication link. Stored in computer memory are data representing a number of bingo cards and a set of games and winning patterns. Stored in keyboard memory is an identifier of the number of cards in play. The keyboard may be powered by a battery and may have a reduced power operating mode to which it switches itself. The keyboard may charge its batteries to full charge individually. The keyboard may have an external power jack to which an external power supply can be connected without interrupting a game in progress. The keyboard may receive data from an external device via its wireless communication link and load that data into its memory. The keyboard may have in its memory a unique identifier that it transmits to the computer.

### TECHNICAL FIELD OF THE INVENTION

The present invention relates to a portable electronic game system and more particularly to a stand-alone electronic bingo game apparatus.

### BACKGROUND OF THE INVENTION

Bingo is game of chance in which each player's chances of winning depends upon numbers drawn at random. Players' compete in against other using bingo cards prepared with a design of five rows of five squares each for a total of 25 squares. The letters B-I-N-G-O is displayed above the grid, with each letter aligned with a vertical column of squares. A two-digit number generally from 1 to 99, but preferably from 1 to 75, appears in every square of the bingo card except the center square, which is designated as a free play. The game also uses a central source for generating random numbers. The random numbers are drawn from a pool of bingo balls. The number of balls corresponds to the range of numbers available on the bingo card. On each ball are found letters and numbers corresponding to those printed on the bingo cards. Each ball includes one letter from the word bingo and one number from the range of numbers printed on the bingo card.

From a conventional air-ball machine or a box, a caller chooses numbers at random one ball at a time and announces the letter and number appearing on the ball. The players with numbers matching the number on the ball called, marks off the number being called using an ink marker called a “dauber”. In the basic form of bingo, as soon as five numbers are covered in a straight line vertically, horizontally or diagonally, the person with the covered numbers calls out “bingo!” Each player that attains “bingo” in a game wins a prize. At the end of each game players turn in their marked cards and must purchase new cards to play another round. Players generally have an opportunity to play more than one bingo card. Often players may attempt as may bingo cards as they have table space available with the idea that the more cards played increases the player's chances of winning bingo. Bingo cards are often sold prepackaged in groups of various denominations. Players can purchase these packaged cards as an added convenience.

With the growth in popularity for the bingo game, more challenging changes have added to the bingo game. First, the basic winning patterns of aligning five numbers on a card either horizontally, vertically or diagonally have been supplemented by a number of complex winning patterns. Some of these winning patterns are as follows:

Postage Stamp where winning numbers are found only in one corner of the array;

Four Corners where winning numbers are found in every corner of the array;

Small Diamond where four winning numbers are found encircling one cell in the array;

Block of Nine where winning numbers are found in a three by three array forming a block of nine numbers;

Crazy T where winning numbers are aligned in a horizontal line and a vertical line to form a “T” shape;

Large Diamond where winning numbers are aligned diagonally encircling a small diamond;

Small Picture Frame where eight winning numbers are found encircling one cell in the array; and

Crazy L where winning numbers are aligned in a vertical line and horizontal line to form an “L” shape.

In addition, some bingo halls are now using “wild numbers” to further add to the complexity of the game. The “wild numbers” are typically called out at the beginning of game play. A “wild number” is identified by the caller before it is drawn. The caller also identifies what characteristic will make the number wild. For example, if the number is even then all even numbers may be marked. Or for example, all numbers sharing the same first digit may also be declared as wild. Other, criteria may be used as well, but it is generally the bingo hall that determines the rules for each game.

Wild card numbers and the winning patterns generally change for each bingo game. In order to achieve “bingo” during any game, the players must know the rules and apply the rules properly during each called number in order to achieve bingo. A problem occurs with players accustomed to playing large numbers of bingo cards. The complexity of tracking several winning numbers for each game combined with the large number of cards played, often increases the chances that a players will miss a possible winning match.

Electronic bingo devices have been developed to help alleviate the problem of tracking large numbers of bingo cards over various patterns; however many of these devices are not well suited for complexities of game play available. While other devices which are well suited for such game play are complex and require computer operators to load the game information before use. One such device is disclosed in U.S. Pat. No. 4,747,600 issued to Richardson which describes a gaming board that includes a communications port used in an electronic bingo system. A computer operator transfers individual game player cards and winning pattern information to the gaming boards from a base station computer. This method has to be performed on each gaming board used in play. The result is added cost and labor to the bingo hall. Another problem with the electronic bingo system is that each game board must be individually connected to the base station in order to be configured. This causes added delay, as players must wait for the operator of the base station to configure their systems.

Some electronic bingo devices have a monochrome character display, which is fabricated with segmented preformed characters. These characters are in fixed positions in the display and the only symbols available are those that can be formed from illuminating combinations of the segments of a character. To display a bingo card, a character display is fabricated with 25 cells in a 5×5 array, each cell formed of two characters. Four such displays are used to display four bingo cards. Other information cannot be displayed along with the bingo cards, and a different number of bingo cards cannot be displayed. When other information is displayed instead of bingo cards, it must be displayed within the format of four 5×5 arrays of two-character cells. The extent of interaction with the user is limited by the monochrome display.

Some battery-powered electronic bingo devices have short battery life, requiring the user to return the device to a recharging station at frequent intervals. Often, battery power will run out during a bingo game, causing the player to lose data entered for that game. When this occurs, bingo hall employees must replace the exhausted batteries, plug in a backup power supply, or issue a new device to the player. All of these options involve an interruption of the game in progress and a recovery period in which the player re-enters information about the interrupted game in progress.

As such, many typical electronic bingo devices suffer one or more shortcomings. Other problems and disadvantages of the prior art will become apparent to one skilled in the art after comparing such prior art with the present invention as described herein.

### SUMMARY OF THE INVENTION

The present invention provides an electronic game device for monitoring bingo cards during a game of bingo. A large number of cards may be played by the player in any game. A series of bingo games with different winning patterns and different wild number rules can be loaded into the device and used to monitor the bingo cards in play. When a card in play exhibits a winning pattern, the device notifies the player. A bit-mapped color display is used to present a selectable number of bingo cards to the user, and other information can be presented in appropriate formats. Reduced power operational modes can be adopted in battery-powered devices to extend battery life. Devices whose batteries have almost run out can be connected to an external power source without interrupting a game in progress.

More specifically, aspects of the invention may be found in a system for monitoring bingo cards during play, the system having a computer and a keyboard communicating via a wireless communication link. Stored in the memory of the computer are data representing a number of bingo cards and a set of games and winning patterns. Stored in the memory of the keyboard is an identifier of the number of cards in play. The identifier of the number of cards in play may be stored in a removable hardware key containing memory which is irremovably connected to the keyboard. The computer system may show the cards in play in formats that display different numbers of bingo cards.

The keyboard may be powered by a battery and may have a reduced power operating mode to which the keyboard switches itself. The keyboard may charge its batteries to full charge individually. The keyboard may have an external power jack to which an external power supply can be connected without interrupting a game in progress.

The keyboard may receive data from an external device via its wireless communication link and load that data into its memory. The computer may blank or flash its display when wireless communication with the keyboard is interrupted. The keyboard may have in its memory a unique identifier that it transmits to the computer. During a bingo game, the computer may exclude messages having a different unique identifier that that of the keyboard that initiated the bingo game.

Other aspects of the invention may be found in a method of monitoring bingo cards during play that uses a computer and a keyboard communicating via a wireless communication link. Steps of the method include storing data in memory of the computer representing a number of bingo cards and a set of games and winning patterns, and storing data in the memory of the keyboard identifying the number of bingo cards in play. Further steps of the method include transmitting entered numbers from the keyboard to the computer, which compares the called numbers on each bingo card in play to the winning patterns and notifies the user when a winning pattern is found on a card in play.

The number of cards in play may be stored in the keyboard by the further step of inserting a removable hardware key that has memory. The method may include the further step of the computer displaying the bingo cards in play in more than one format, each format showing a different numbers of cards.

The keyboard may be powered by a battery and the method further include the steps of monitoring the status of the keyboard and, in response to that status, entering a reduced power mode of operation. The keyboard may be powered by more than one battery and the method further include the step of recharging one battery before recharging the others. The keyboard may have an external power connector and the method further include the step of connecting an external power supply without interrupting a game in progress.

The method may also include the steps of the keyboard communicating with an external device using the wireless communication link and loading data from the external device into the memory of the keyboard.

Additional aspects of the invention may be found in a method of supplying bingo card monitoring game devices. The steps of the method include providing more than one computer having a wireless transceiver and loading into the memory of that computer data representing a number of bingo cards, a set of games and a set of winning patterns. Further steps include accepting an order from a player specifying the number of cards to be played by that player, providing a keyboard with a wireless transceiver, and loading the memory of the keyboard with data including the number of cards specified by the player. The method also includes the step of initiating a bingo game by using the keyboard to communicate with one of the computers.

The memory of the keyboard may be loaded by the step of inserting a hardware key including memory. The keyboard may be powered by a battery and the method include the steps of monitoring the status of the keyboard and entering a reduced power mode of operation in response to that status. The keyboard may include in its memory a unique identifier and the method further include the step of transmitting that identifier as part of any wireless communications sent from the keyboard. The step of initiating a bingo game may also include the computer storing the unique identifier received from the keyboard and ignoring subsequent messages during the playing of the game that do not contain the stored unique identifier.

As such, an apparatus and method for monitoring bingo cards during a game of bingo are described. Other aspects, advantages and novel features of the present invention will become apparent from the detailed description of the preferred embodiments when considered in conjunction with the accompanying drawings.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 is a schematic view of a game system according to the present invention;

FIG. 2 is a top view of the keyboard of the game system of FIG. 1;

FIG. 3 is an oblique view of the left side and back of the keyboard of FIG. 2;

FIG. 4 is a block diagram of the circuitry of the keyboard;

FIG. 5 is an illustration of a display format showing nine bingo cards;

FIG. 6 is an illustration of a display format showing one bingo card; and

FIGS. 7-13 are flow diagrams of the software program of the game device.

### DETAILED DESCRIPTION OF THE INVENTION

Exemplary embodiments of the invention are illustrated in the Figures, like numerals being used to refer to like and corresponding parts of the various drawings.

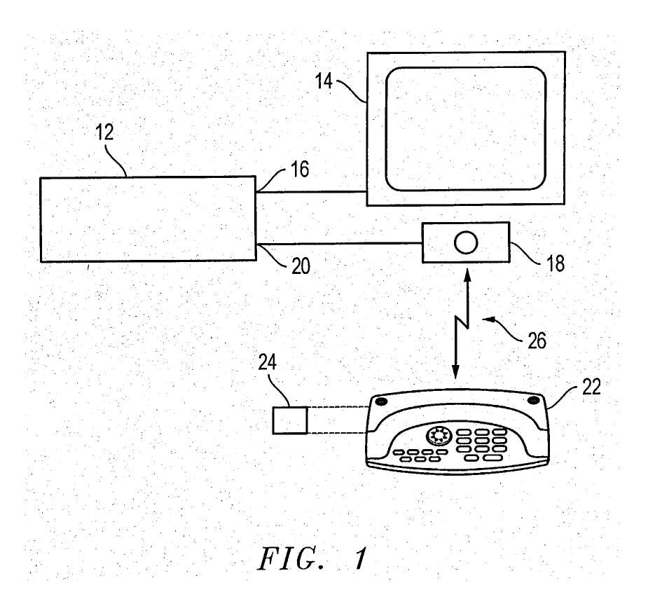

FIG. 1 illustrates an embodiment of the present invention. Game system 10, includes computer system 12, for example a personal computer, and bit-mapped color monitor 14, connected to the monitor port 16 of computer system 12. Infrared (IR) transceiver 18 connects to serial port 20 of computer system 12 and enables wireless communication via IR radiation 26 with keyboard 22, which also includes an IR transceiver. Bingo cards, a list of the series of games to be played in a bingo session, and the winning patterns for each of those games are provided stored in the memory of computer system 12 and, when the keyboard 22 is activated by the mechanical receipt of a hardware key 24, game system 10 is adapted to operate with a bingo player in accordance with the rules of play defined by the bingo hall. The hardware key 24 is inserted by the bingo hall personnel from an assortment of hardware keys that are sorted according to the quantities of bingo cards provided by the bingo hall. A color monitor 14 provides a general-purpose display that can be configured to display bingo cards and other information. Keyboard 22 allows the player to control the game system 10 and input called bingo numbers during game play.

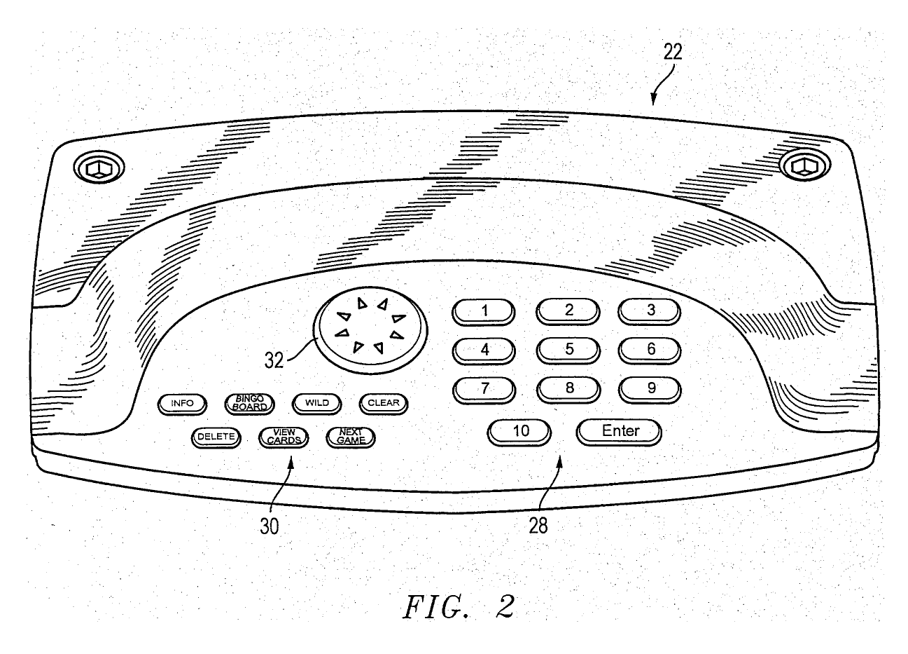

The top face of keyboard 22 is shown in FIG. 2. Numeric keypad 28 includes keys designated for numbers 1-9 configured in a 3-by-3 array, with number “0” located under the array. An “Enter” key is located below the array adjacent the number “0” key. Function keypad 30 provides access to the various display modes, allows for viewing of the bingo cards, promotes changing of winning patterns and clears player memory. These functions will be discussed in greater detail herein and are achieved using the following keys: an “Info” key, a “Bingo Board” key, a “Wild” key, a “Clear” key, a “Delete” key, a “Next Game” key and a “View Cards” key. The top face of the keyboard 22 also includes a mouse pad 32 used to move a cursor about monitor 14, shown in FIG. 1.

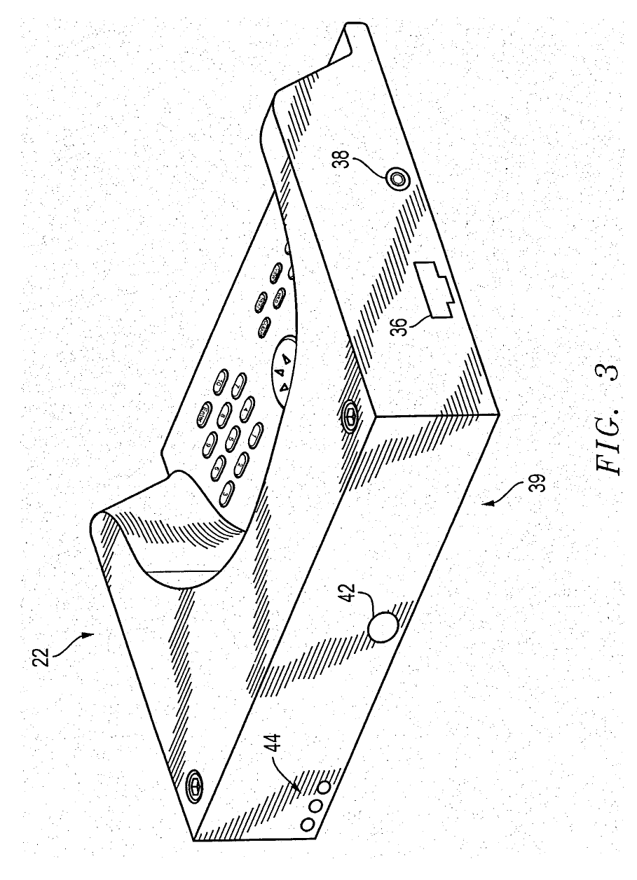

The left and back sides of the keyboard are shown in FIG. 3. Located on the left side of the keyboard 22 is a hardware key slot 36 for securing the hardware key 24 within the device. Also located on the left side of the housing is an external power jack, or connector, 38. Located on the back side of the keyboard 22 are red, yellow and green status LED indicators 44 which indicate the operational status of the circuitry of the keyboard. These status LED indicators will be discussed in more detail herein.

Also on the back of the keyboard is an infrared (IR) window 42, transparent to infrared radiation, which covers an IR transceiver inside the keyboard, enabling the keyboard to communicate with the game system and other external devices using an IR communication link.

Located on the bottom side of the keyboard 22 are charging contacts 39 (not shown in FIG. 3). The keyboard can be placed in a recharging cradle having mating contacts to recharge the batteries in the keyboard.

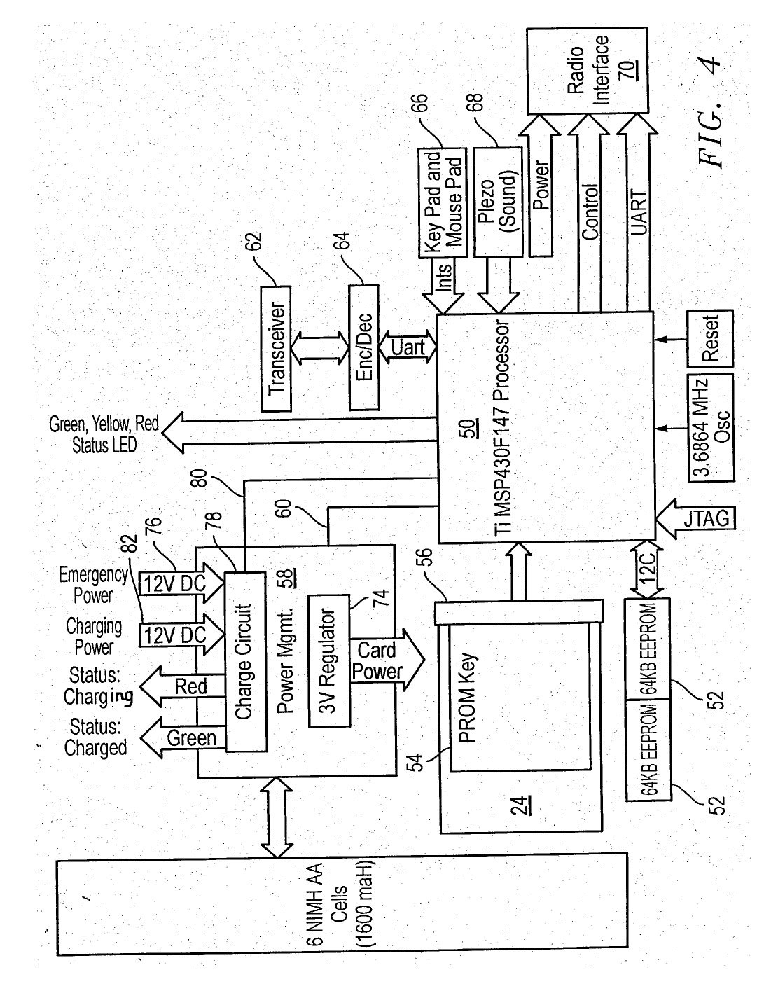

The electronic bingo device is controlled by the circuitry shown in FIG. 4. A central processing unit (CPU) 50 operates in cooperation with a control program stored in non-volatile electrically erasable programmable read-only memory (EEPROM) 52. Upon activation of the CPU, the control program is executed from keyboard EEPROM using Flash RAM in the CPU for data storage. Keyboard EEPROM 52 also contains an unique identifier for the keyboard. A CPU of the type suitable for this purpose is the Texas Instruments MSP 430F147 processor.

CPU 50 connects to infrared (IR) transceiver 62 through encoder/decoder 64. IR transceiver 62 can communicate with external devices, such as computer system 12 of FIG. 1, by transmitting and receiving data via IR radiation 26.

CPU 50 also connects to keypad circuitry 66. When the user presses buttons in keypads 28 or 30 of FIG. 2, keypad circuitry 66 generates an interrupt to CPU 50, which then scans the keypad circuitry to determine the pressed key. As explained herein, the identity of the pressed key is transmitted to computer system 12 to be processed by the bingo card monitoring program there.

A piezoelectric sound transducer 68 is also connected to CPU 50, to enable the CPU to alert the user by emitting sounds. A radio interface is also connected to CPU 50 to enable it to communicate with external devices by transmitting and receiving data via radio frequency signals. While the description herein of the communication between the keyboard 22 and the computer system 12 describes an IR link, it should be understood that a radio frequency link could also be used.

Power management circuitry 58 monitors the voltage levels of the keyboard power supply. Upon sensing low battery voltage, power management circuitry 58 signals that condition to CPU 50 over line 60. CPU 50 then indicates the low battery condition to the user by blinking the yellow LED in the status LED indicators 44 of FIG. 2.

CPU 50 monitors activity on the keypad, IR transceiver and radio interface, and puts itself into a reduced power “inactive” mode when there has been no activity for 30 seconds. The CPU can be returned to active mode from “inactive” mode in response to signals received from the IR transceiver or the radio interface, and upon an interrupt from the keypad circuitry indicating keypad activity.

Twin batteries 72 are connected in parallel to power management circuitry 58. Voltage regulator 74 produces power for the other circuitry of the keyboard. Voltage regulator 74 can also draw emergency power 76 from emergency power jack 30 of FIG. 3 when an external power source is connected. The output voltages of voltage regulator 74 does not fluctuate when an external power source is connected to emergency power connector 30, thereby preventing any interruption in the operation of the keyboard.

While the twin batteries 72 operate in tandem to power the keyboard, they are individually connected to charging circuitry 78. Charging circuitry 78 receives charging power 82 from charging connectors 39. When charging power is applied to the charging connectors, the charging circuitry, under the control of CPU 50 via charging control line 80, begins charging one of the two batteries. Once that battery is fully charged, the charging circuitry then begins charging the other battery. Once the second battery is fully charged, CPU 50 indicates that situation to the user by blinking the green LED in the status LED indicators 44 of FIG. 2. During the period that one battery is fully charged and the other is partially charged, charging power can be removed and the keyboard operated normally.

CPU 50 is also connected to hardware key EEPROM 54, contained in the hardware key 24 and electrically connected to the CPU when the hardware key is inserted in the hardware key slot 36 in the keyboard where it engages hardware key socket 56 to provide electrical communication between the CPU 50 and hardware key EEPROM 54. The data stored in a type of hardware key known as a player key includes the number of cards purchased by the player. CPU 50 can also receive this information from an external device via the IR transceiver or the radio interface and store it in keyboard EEPROM 52. In these situations, hardware key EEPROM 54 is not used.

Other types of hardware keys include a game key, which contains a list of the games and parts of games to be played in a bingo session, the wild number rules for those games and the winning patterns for those games; a card set key, which contains the collection of bingo cards to be used by the game system; and a code key, which contains programs for the keyboard CPU 50. When one of these types of hardware keys is inserted into the game device, the CPU 50 reads an identifier in the memory of the key and recognizes the type of data contained in the key. The CPU then transfers the data from the hardware key via the IR transceiver or RF interface into the memory of computer system 12. When the keyboard is subsequently powered up with a player key, the data stored in the memory of the computer system will be used in performing the function of monitoring bingo cards.

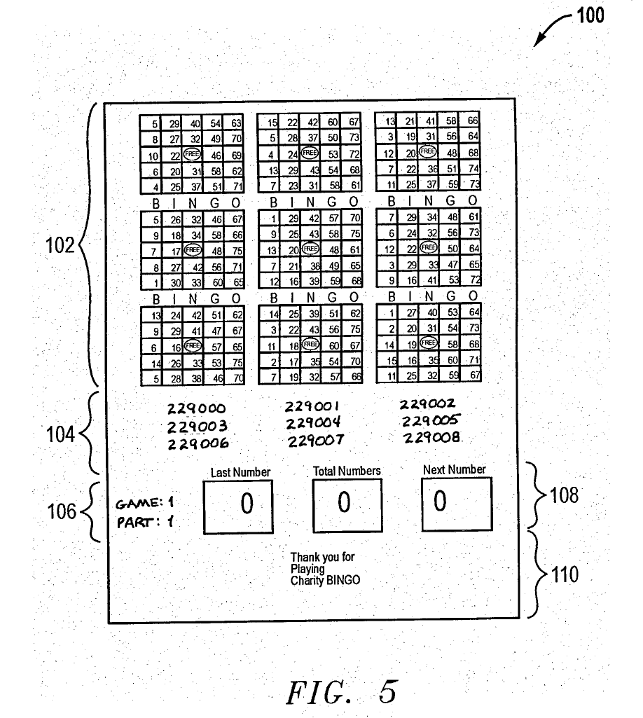

FIG. 5 illustrates a display format 100 showing nine bingo cards at once. The nine cards appear in a three-by-three array at the top of the display in section 102. The letters B-I-N-G-O are displayed between the cards to label the columns of the cards. The serial numbers of the nine displayed cards are shown below the displayed cards in section 104 of the display. The number and part of the game currently being played are displayed in section 106 of the screen, to the left below the display of serial numbers. Section 108 of the display, to the right below the display of serial numbers, shows called number information about the called numbers entered by the user: the last called number entered, the total count of called numbers entered, and the number currently being entered by the user on the numeric keypad. A general-purpose message display area 110 is provided at the bottom of the screen.

This display format permits an additional type of bingo game to be played, in which a winning pattern can occur on certain of the cards. For example, a diagonal bingo on the three leftmost cards might be the winning pattern for such a multiple card game.

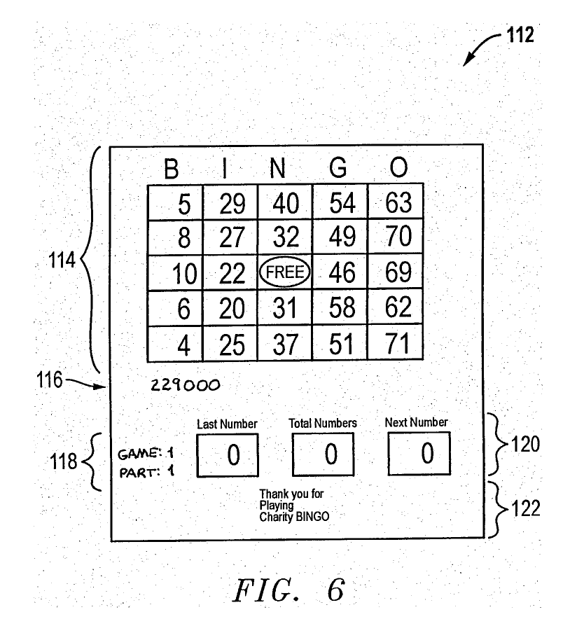

A display format 112 for displaying a single bingo card is shown in FIG. 6. Visually impaired users can more easily read the large type utilized in this display format. This format has the same sections as the nine card format illustrated in FIG. 5: the card is displayed at the top of the screen in section 114, the serial number of the card is shown below that in section 116, below that are shown the game and part numbers in section 118 to the left and the called number information in section 120 to the right, and at the bottom of the screen is message display area 122.

Other modified bingo games can be played using the bitmapped color display of the present invention. Cards can be displayed with some squares holding two numbers, rather than the usual single number. This is possible because the numbers displayed within a square can be made smaller and shifted, in order to fit two numbers in the same square. In another modification to the usual bingo card, certain squares on a player's cards can be marked with a star to signify that a bingo including that square wins a special prize. This can be done by displaying the star in the background of the square in a contrasting color to the background color of the other squares of the bingo card.

The “Bingo Board” key in the function keypad 26 of FIG. 2 allows the user to cycle through the display formats showing one, four or nine cards, and a display format called the “Flashboard”, showing the called numbers entered by the user and the winning patterns for the current game. The “View Cards” key in the function keypad 26 serves to cycle through all the cards being played, in whatever display format the user has selected using the “Bingo Board” key.

Computer system 12 of FIG. 1 operates under a multitasking operating system, such as Microsoft® Windows NT®, which allows interdependent tasks, or threads, to run individually. A multi-tasking operating system interrupts and restarts each task upon the occurrence of certain events, such as hardware interrupts and inter-task communications. When the bingo card monitoring program of the present invention starts running it initiates separate threads to manage communication with the keyboard, to monitor the cards being played by the user in a bingo game, and to update the display as the user enters called numbers. The communication manager thread receives communications from the keyboard identifying keys pressed by the user and communicates those key identifiers to the card monitoring thread using inter-task communication facilities provided by the multi-tasking operating system. Once the card monitoring thread has updated its representations of the state of each of the cards in play, it sends an inertias message to the display update thread, which determines whether any data currently being displayed has changed and, if so, redraws that data on the display device 14.

The communication manager thread operates by sending a poll message to the keyboard at regular intervals requesting a status report. The reply message from the keyboard contains the keyboard unique identifier stored in the EEPROM of the keyboard and the identity of any keys pressed by the user. Other poll messages may be sent by the computer system, for example requesting data stored in the keyboard EEPROM 52 or in the hardware key EEPROM 54. When the communication manager thread is first run, if it receives no reply to its poll message it sends an intertask message to the display update thread asking it to display a “No keyboard detected” message on the display device 14. When the communication manager thread first receives a reply from a keyboard it sends another intertask message to the display update thread asking it to display a “Please press Enter” message on the display device 14, prompting the user to press the Enter button on the keyboard. Once that button is pressed, the communication manager thread sends an intertask message to the card monitoring thread instructing it to commence monitoring operations.

If no communications are established, the communication management thread will continue to poll for a keyboard. While there is no communications, the screen will turn red and a message indicating that no keyboard has been detected will appear on the screen. The keyboard will no respond to communications requests from the communications management thread unless it has the keyboard ID embedded in the request. The one exception to this rule is when the communications management thread is polling for a new keyboard. There is a special status request packet that any keyboard will respond to giving the communications thread its current status and identification. Alternately, the communication manager will store the keyboard unique identifier from the most recently received status reply message in memory. Once the card monitoring thread recognizes that a bingo game has begun, it may send an intertask message to the communication manager thread instructing it not to accept replies from a keyboard having a different unique identifier than the keyboard that was used to initiate the bingo game.

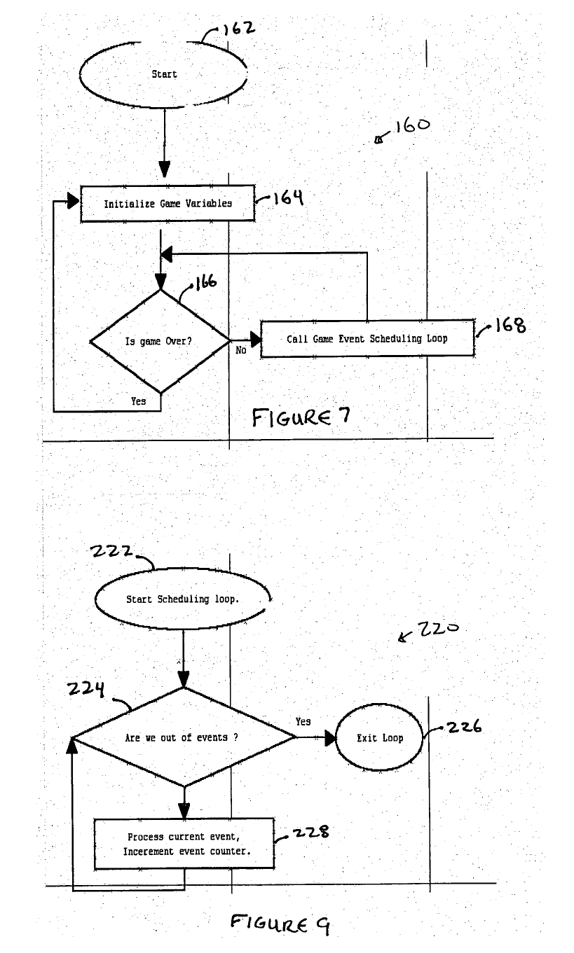

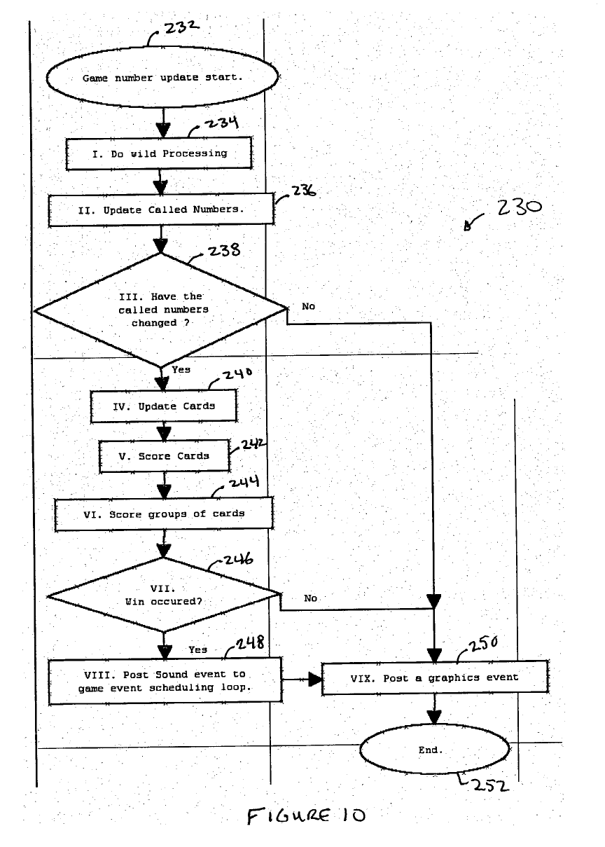

FIG. 7 is a block flow diagram of an exemplary main game thread. To begin the method 160, initializes the game variables as seen in block 164. The system then determines whether the game is complete as seen in block 166. If the game is not complete, the main game thread calls the game event scheduling loop (depicted in FIG. 9) as seen in block 168. If the game is complete, the system re-initializes for a next game or, if a next game has not been purchased, the thread may terminate or alert the user, among others.

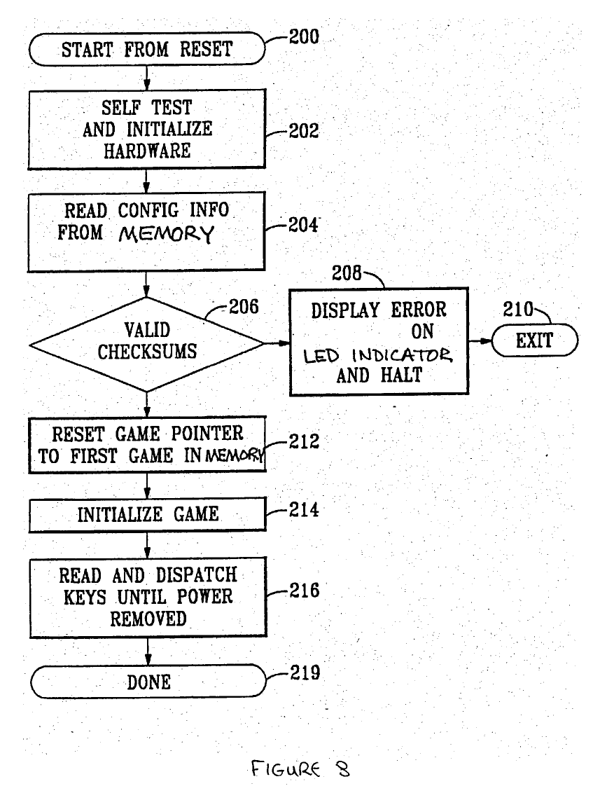

FIG. 8 shows an alternate main program routine for an embodiment of the present invention. The control program is started either upon inserting the game key into the game slot or at any time the CPU is reset by the watchdog processor at step 200. The program self tests and initializes the hardware in a conventional manner at step 202. The configuration information including the winning patterns, wild card numbers and bingo card allocation numbers are read from memory at step 204. Next the bingo cards allocated to the player may be compared with a checksum number to ensure the bingo card information in memory is valid at step 206. The cards may be 20 bytes. The first 13 bytes may describe the card, the next three may be the serial number, the next may be an optional star position and the last three may be reserved for future expansion. However, the cards may use fewer or more bytes for various purposes in various orders. Alternately, Each bingo card entry may use 13 bytes for card data and 3 bytes for providing a unique serial number to comply with various regional bingo regulations and a checksum byte. The checksum is the sum of bytes 0 through 15 with a carry wraparound. If the sum of bytes 0-15 does not match the checksum value, the data may be considered invalid and an error may be signaled via the LED indicator 36 of FIG. 1 at step 208, among other alert option, and the program stops at step 210. Otherwise, if the bingo card data is valid, the program resets a game pointer variable to the first game listed in the game key at step 212. The game data including winning patterns and wild card data is loaded into the game variable to initialize the game at step 214. The program at step 216 then calls a game event scheduling loop (FIG. 9). Upon return from the game event scheduling loop 218, the program may terminate at step 219 if the player has played all of the allotted games or return to steps 204 or 212.

FIG. 9 illustrates the game event scheduling loop. The method starts by determining whether more events exist as seen in block 224. An event can be timed, fired, or forced. Timed events include checking for key presses every 30 milliseconds, updating screens every 33 milliseconds, blinking display values, and battery events, among others. Time periods are shown for illustrative purposes and may vary. Fired events may include playing a sound, among others. However, the events may take various forms. If events exist, the events are processed and the event counter is incremented as seen in block 228. The availability of events may then be tested again. If no events exist, the routine may exit the loop and return to the main program or thread as exemplified in FIGS. 6 and 7. The main program thread may then call the game event thread again.

The system has arrays of structures which have embedded function pointers for each key. When a key event is processed a routine iterates through these structures until it finds the structure that matches the key pressed. When this structure is found the embedded function is called. This allows a great deal of flexibility when processing the keys. Different arrays of structures can also be used to describe what should happen on each key press. For example when the in game submenu is showing the #2 key will allow a user to change a dauber. When the dauber select sub-menu is up the #2 key will select option 2, while there is no current game being played the #2 key will do nothing and while playing the #2 key will adjust the current number in the input buffer.

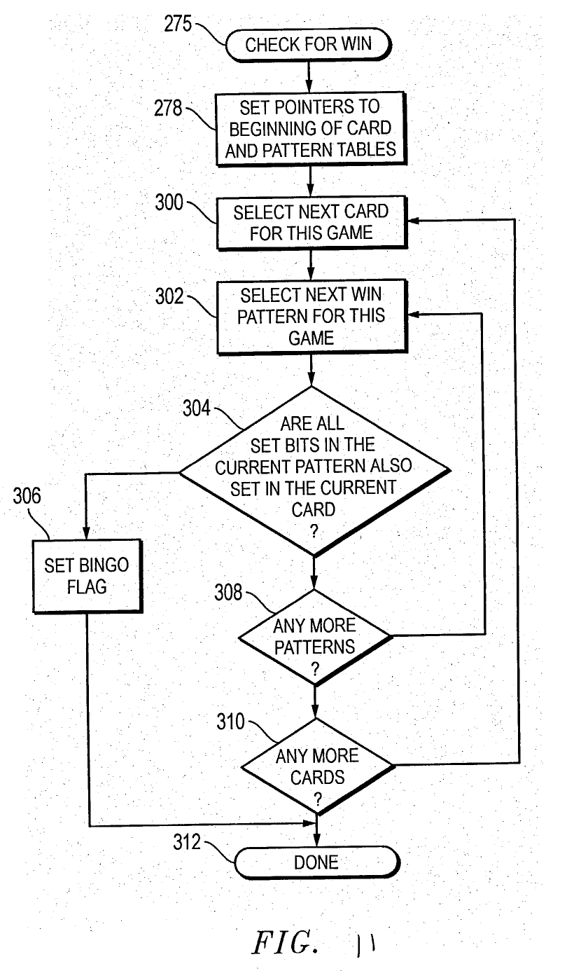

In other examples, if the number is entered the entered number variable is updated. If the clear key has been pressed the entered number variable is cleared to zero. If the enter key has been pressed the game number updating routine (FIG. 10) is executed. If the delete key has been pressed an undaub flag is set. If the wild key has been pressed a wild flag is set. If the Info key has been pressed the in-game menu will appear which may allow the user to change the language that the game is played in, change his/her dauber shape, and change his/her dauber color, among others. If the Bingo Board Key has been pressed, the Bingo Board display mode may be changed. If the View Cards key has been pressed the entered number variable is cleared to zero. If the Next Game key has been pressed for at least two seconds, the next game number is updated. The display may be updated in accordance with a timed event.

FIG. 10 shows an exemplary game number update routine. This routine may be activated upon detecting an enter key, among others. If the enter key has been pressed, and the last key entered was a number, the number stored in the entered number variable is added to the list of called numbers and the number is marked on each card containing that number in a winning pattern. If the wild key was pressed prior to pressing the enter key, the number entered will be used to mark all numbers in a winning pattern, meeting the requirements of the wild card rules. The method begins with wild card processing as seen in block 234. If a wild number has been entered, the system may generate all possible numbers associated with the wild number. The system may then update the called numbers as seen in a block 236. This process adds or deletes numbers from the called numbers list. The system determines whether the called numbers have changed as seen in a block 238. If not, the system posts a graphics event as seen in a block 250. If the numbers have changed, the system updates the cards as seen in a block 246. This involves updating each played card face and matching pattern according to the new called number. The cards are then scored and ranked according to how close it is to matching a winning pattern as seen in a block 242. For games with multiple cards per sheet, each sheet is assembled and scored fro how close the sheet is to winning as seen in block 244. The system looks for the winning criteria on each sheet as seen in block 246. If there is no win, the system posts a graphics event as seen in block 250. If there is a win event, the system posts a sound event as seen in a block 28 and a graphics event as seen in block 250. The updating routine then terminates or returns to another thread.

The above method is exemplary. The method steps may occur in differing orders. Some steps may be omitted in other embodiments. As such, alternate methods may be envisaged.

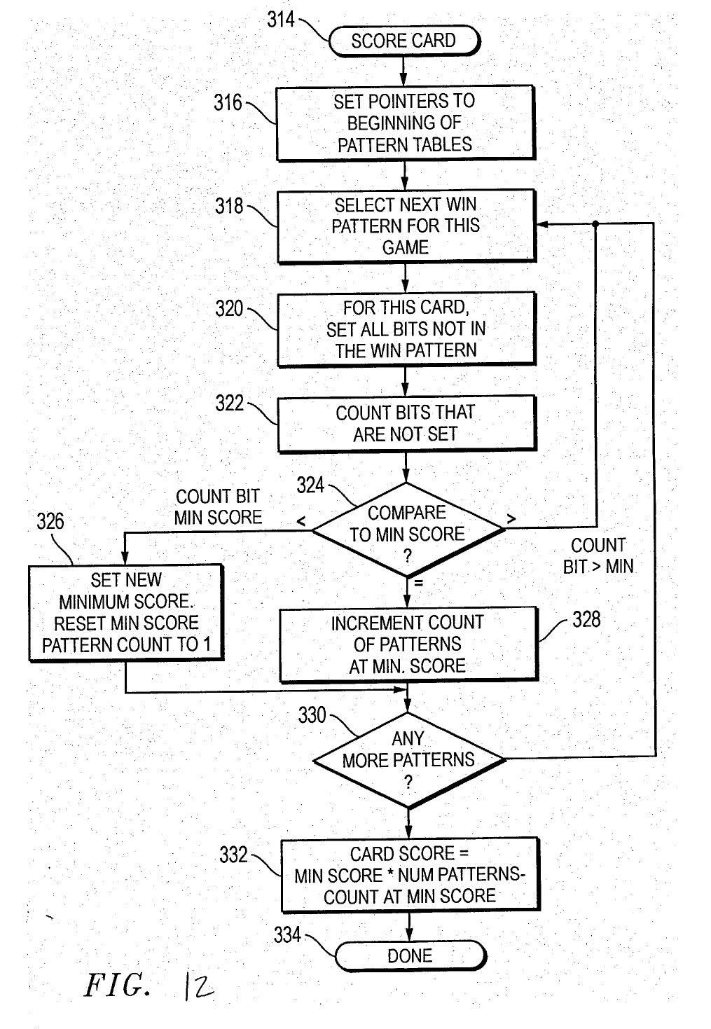

In an exemplary embodiment, a check for win routine 276 (FIG. 11) begins scanning for a win by initializing the pointers for winning patterns in play and cards in play at step 298. A select next card step loads the first card mark mask at step 300. A select next win pattern step loads the next win pattern to be checked for this game at step 302. If the win pattern bits match bit in the bingo card mark mask at step 304, then the bingo flag is set to mark the win, the routine then returns to the game number updating routine at step 312. Otherwise, more patterns are checked at step 308. If there are more patterns then the program returns to step 302. Otherwise more cards are checked at step 310. If more cards exist the program returns to step 300. Otherwise the program returns to the game number updating routine at step 312.

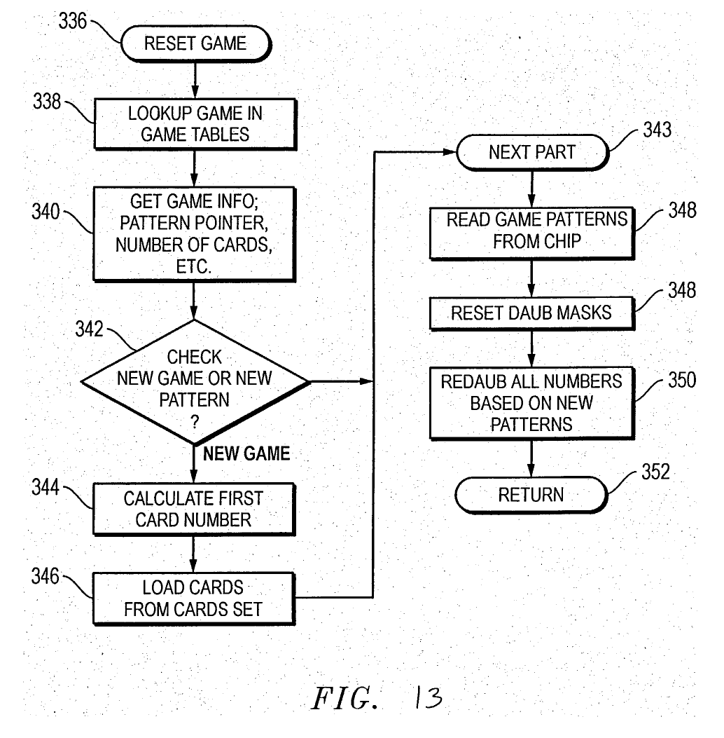

An exemplary score card routine 314 in FIG. 12 checks whether the loaded card has earned Bingo. The pointers that track the winning patterns are first set to the beginning at step 316. Next, the next winning pattern is loaded for comparison with the bingo cards at step 318. The card mask bits are set to “on” or “1” at step 320 and the bits not set are counted at step 322. The number of not set bits are compared to a minimum score variable at step 324. If the card bits are less than the minimum score, then the minimum score is updated to the value of the bit count form step 322. The minimum score pattern count is then updated. The program then jumps to step 330 to check for more patterns. If the comparison of the minimum score to the counted not set bits is equal, then the count of patterns at min. score is incremented and the program jumps to step 330. If the count bit are greater than the minimum score the program returns to step 318. At step 330, if there are more patterns the program jumps to step 318; otherwise the card score is updated at step 332. The card score is equal to the minimum score multiplied by the number patterns minus the count at minimum score. The program then returns to the game number updating routine at step 334.

An exemplary next game display routine 336 in FIG. 13 loads in the winning pattern information for the part of a continuing game or loads in the winning patterns for a new game. The next game information is loaded from the game table at step 338 and gets the game info including the pattern pointer and number of cards and wild card data for the game at step 340. A check is made to determine whether this information is a new game or a new part of an existing game at step 342. If the game information is a new part of an existing game the routine jumps to step 343.

Otherwise, the routine sets up the bingo device to play a new game. A first card number is calculated at step 344 to determine how many cards have been allotted from the bingo card memory for this game at step 344. Then the corresponding number of bingo cards is loaded from the list of bingo cards at step 346. The program then jumps to step 343 to load in the winning pattern information and wild card information for the next round of play. Winning patterns from the memory of computer system 12 are read at step 348. Next, recheck for a win using the new win patterns at step 349 using the check for win routines. Finally, all numbers are re-scored based on the new patterns at step 350 by jumping to the score card routine until all cards have been scored.

However, the methods of FIGS. 11, 12, and 13 may or may not be included or may take alternate forms.

An example of the operation of the embodiment of the present invention described herein is now given. A bingo hall will provide a number of computer systems 12 with displays 14 and IR transceivers 18, but without keyboards 22, placed around the hall on tables. These computer systems will already have in their respective memories card set data, each defining a unique collection of bingo cards from which the player's cards are chosen at the beginning of a bingo game. Each keyboard has an assigned cardset number. When the game initialized to a keyboard the correct cardset is loaded into the game. In this way, it can be guaranteed that no two systems are using the same cards. The computer systems will also have in their respective memories game data: including a list of the games and parts of games to be played in a bingo session, the wild number rules for those games and the winning patterns for those games.

A prospective player will first visit a point-of-sale station where he receives a keyboard with an installed player key identifying the number of cards he has chosen to play in each game of the bingo session. Alternatively, the player may receive a keyboard which has had the player data loaded into its memory from a point-of-sale programming device via the IR transceiver or RF interface. The player then proceeds to an unused computer system and places the keyboard in a position to communicate with the computer system. The communication manager thread of each computer system is repetitively sending out polling messages via its IR transceiver and, once in position, the player's keyboard responds to the next polling message. The communication manager then asks the player to hit enter on the keyboard to confirm that he/she wishes to use this station. The player data may not be requested from the keyboard until the player hits enter again to play the game. The player data from the memory of the keyboard is then requested by the communication manager thread of the computer system and loaded into computer system memory. The player then proceeds to play bingo.

If the LED indicator on a player's keyboard signals low battery voltage, a bingo hall employee can provide an emergency power supply for the player to plug into his keyboard and continue playing any game already in progress without interrupting the game or losing called numbers that had been entered up to that point of play.

When the player first places his keyboard in front of an unused computer system and presses the Enter button as prompted by the computer system, the first game is selected. Entering a called number by pressing one or two numbers followed by the ENTER key will cause that called number to be daubed.

If a number is displayed on the bingo board that has not been called, it may be removed by pressing one or two numbers and the DELETE key. Pressing the BINGO BOARD button will cycle the display to a format showing all numbers that have been entered. The normal display will return when the BINGO BOARD button is pressed again.

If the daubed numbers on one of the cards in play match a winning pattern, an audible alarm will sound and the numbers on that card that form the winning pattern will flash. All buttons will continue to operate so that corrections can be made if the bingo is the result of an erroneous entry.

Some games allow for Wild numbers to be entered at the beginning of a game. These numbers are daubed by entering a number followed by the Wild Button, followed by the Enter key. They may be undaubed by entering the number, followed by the Wild Button, followed by the Delete key. The following sections describes the wild algorithms that may be used:

The wild algorithm is selected per game as determined by the house. The algorithm to be used in each game is stored in the game data that configures the game device for play. When the wild number is entered, a group of numbers is daubed simultaneously based on the selected wild algorithm, which may be one of the following:

Even/Odd—If the number entered is even, all even numbers on the card will be daubed. If the number entered is odd, all odd numbers on the cards will be daubed.

Ending-In—All cards ending in the same number will be daubed.

Both—Begins or ends in a given number.

The identification of winning patterns is now described. Winning patterns can consist of from 1 to 25 positions on a card. This can be identified by a vector of 25 bits. A one bit in any position indicates that the position on the card corresponding to that bit is required by that pattern. For example, the following win mask identifies the common bingo pattern of all numbers in the first column being daubed: 000000000000000000011111. And this win mask identifies the pattern of all numbers in the first row being daubed: 0000100001000010000100001. These numbers can be conveniently fitted into a long integer (32 bits). The upper 7 bits are reserved.

The storage of bingo cards is now described. Flash RAM 52 in FIG. 3 includes memory space to house data representative of at least 1,000 bingo cards. This data includes 25 numbers between 1 and 75 randomly chosen for each of the bingo cards and may use 13 bytes for each card or at least 13 kilobytes of memory. The cards may be 20 bytes. The first 13 bytes may describe the card, the next three may be the serial number, the next may be an optional star position and the last three may be reserved for future expansion. However, the cards may use fewer or more bytes for various purposes in various orders. Alternately, Each bingo card entry may use 13 bytes for card data and 3 bytes for providing a unique serial number to comply with various regional bingo regulations and a checksum byte. The card cells are numbered from 0-24 in which this numbering identifies bits in the patterns and the storage of numbers in the games in play arrays. It will be appreciated by those skilled in the art that storing each of the numbers for each cell conventionally would require at least one byte for each cell or 25 bytes per card. In order to save memory space and cut down on the memory costs, the data has been compressed.

Bingo cards are stored in the Flash RAM in a table with entries of the form:

| Byte(s) | Function |
|---|---|
| 0-12 | Canonical Card |
| | Representation |
| 13-15 | Serial Number |

The Canonical Card Representation is discussed above. The Serial Number is a number assigned to the card in the master card set. The Checksum is the sum of bytes 0 through 15 with carry wraparound.

The storage of game data in Flash RAM 52 and game key 44 is now described. One segment of the game data is the win pattern table, which contains a list of all winning patterns. Note that most winning patterns may require multiple entries in the table. For example, the standard bingo winning pattern of any row, any column, or the two diagonals would require 12 entries: one for each of the 5 rows; one for each of the 5 columns, and one for each of the two diagonals.

Each entry in the win pattern table may be in various formats including one of the following two formats:

Pattern Mask

| Bits | Function |
|---|---|
| 0-24 | Win |
| | Pattern |
| 25-31 | 0000000 |

Group Header

| Bits | Function |
|---|---|
| 0-24 | Number of |
| | Patterns |
| 25-29 | Start Pattern |
| 30 | 1 |
| 31 | 0 |

However, various formats for the win pattern table may be envisaged.

The entries are arranged in an array with 0 referring to the first element in the array, as shown below. The number of entries in this table is limited only by the memory in the game device.

$$\begin{matrix}\begin{matrix}\begin{matrix}Win Mask 0 \\ Win Mask 1\end{matrix} \\ ⋮\end{matrix} \\ Win Mask N\end{matrix}$$

Another segment of the game data is the Game/Part Table, which contains authorized game numbers, the number of games, and the winning patterns for each game. There are two formats for entries in this table: the game header and the part header. Single part games will have one game header, followed by one part header. Multipart games will have one game header followed by as many part headers as there are parts to the game. Various header formats may be envisaged.

The method of scoring cards is now described. In bingo, all that really matters for winning is if a pattern is complete. The card either has a pattern completed or it does not. But, in order to determine which are the best cards in play, it is necessary to give each card a score. This score is determined as follows: First, cards are scored by the pattern closest to a win. For example a card that is one away from winning on some combination is better that a card that has no combination better than two away. Next, the cards that are at any given rank are then further ranked by how many different combinations are at the minimum. For example a card that is one away on two different patterns is better that one that is one away on only one pattern. Lastly any ties are broken by where the card was in the previous ranking. This prevents the cards from jumping around in order when the score has not changed as a result of sorting them. These scores are combined as follows:

Score=(Dₒₙ*Nₚₐₜₜₑᵣₙₛ−Nₒₙ)*N_{cip}+R_{old}

where:

| | |
|---|---|
| Dₒₙ | Number of numbers required for win on the best pattern on |
| | this card. |
| Nₚₐₜₜₑᵣₙₛ | Number of win patterns in the current game. |
| Nₒₙ | Number of patterns that are at Dₒₙ from a win. |
| N_{cip} | Number of cards in play in this game. |
| R_{old} | Card rank after last scoring pass. |

The Scores are then ordered from best to worst. The best is assigned rank 0 and each card is assigned a successively higher rank in order of its score, with the worst receiving a rank of NumCards-1. After the first ranking, all the scores will be unique since Rold is unique.

As such, an apparatus and method are described for monitoring bingo cards. In view of the above detailed description of the present invention and associated drawings, other modifications and variations will now become apparent to those skilled in the art. It should also be apparent that such other modifications and variations may be effected without departing from the spirit and scope of the present invention as set forth in the claims that follow.

What is claimed is:

1. A system for monitoring bingo cards during play, comprising:
a computer system comprising a display and memory;
instructions in the memory of computer system for monitoring bingo cards during a game;
bingo card data stored in the memory of the computer system representative of a plurality of bingo cards;
game data stored in the memory of the computer system representative of a set of games and a set of winning patterns;
a keyboard comprising memory;
player data stored in the keyboard memory including an identifier for the number of bingo cards in play; and
a wireless communication link connecting the keyboard and the computer.

2. The system of claim 1, the keyboard memory further comprising a removable hardware key with memory containing the player data.

3. The system of claim 1, further comprising instructions in the computer system memory for a plurality of display formats, each format displaying a different number of bingo cards.

4. The system of claim 1, the keyboard further comprising a battery power supply.

5. The system of claim 4, wherein the keyboard has a reduced power operating mode, the keyboard further comprising circuitry to switch the keyboard to the reduced power operating mode.

6. The system of claim 4, the battery power supply further comprising power management circuitry and a plurality of rechargeable batteries, wherein the power management circuitry charges one battery of the plurality of batteries completely before charging the remaining ones of the plurality of batteries.

7. The system of claim 4, the battery power supply further comprising an external power jack, where connection of an external power source to the external power jack does not interrupt a game in progress.

8. The system of claim 1, further comprising instructions in the keyboard memory for receiving data from the wireless communication link into the keyboard memory.

9. The system of claim 1, wherein the wireless communication link is bi-directional.

10. The system of claim 9, further comprising instructions in the computer system memory for interrogating the keyboard for status information.

11. The system of claim 9, further comprising instructions in the computer system memory to blank the computer system display when no response is received from the keyboard in response to communications from the computer system over the wireless communication link.

12. The system of claim 1, further comprising: a unique identifier stored in the keyboard memory; and instructions in the keyboard memory to transmit the unique identifier with messages sent to the computer system over the wireless communication link.

13. The system of claim 12, further comprising:
instructions in the computer system memory to store the unique identifier of a keyboard that initiates a bingo game in the computer system memory;
instructions in the computer system memory to exclude messages during the playing of the bingo game that do not contain the unique identifier of the keyboard that initiated the bingo game.

14. A method of monitoring bingo cards during play using a computer system and a keyboard, the computer system and keyboard communicating through a wireless communication link, the keyboard including memory, the method comprising the steps of:
storing bingo card data in the memory of the computer system representative of a plurality of bingo cards, including bingo cards in play;
storing game data in the memory of the computer system representative of a set of games and a set of winning patterns;
storing player data in the memory of the keyboard including an identifier for the number of bingo cards in play;
transmitting called numbers entered at the keyboard from the keyboard to the computer system over the wireless communication link;
the computer system comparing the called numbers on each bingo card in play to the winning patterns; and
the computer system notifying the user when one of the bingo cards in play contains called numbers in a winning pattern.

15. The method of claim 14, wherein the step of storing game data further comprises the step of inserting a removable hardware key including memory containing the player data.

16. The method of claim 14, wherein the computer system includes a display, the method further comprising the step of displaying the bingo cards in play in a plurality of formats, each format displaying a different number of bingo cards.

17. The method of claim 14, wherein the keyboard further includes a battery, the method further comprising the steps of:
monitoring the operational status of the keyboard; and
placing the keyboard into a reduced power mode of operation in response to the monitored status of the keyboard.

18. The method of claim 14, wherein the keyboard further includes a plurality of rechargeable batteries, the method further comprising the step of recharging one battery to completion before recharging the remainder of the plurality of batteries.

19. The method of claim 14, wherein the keyboard further includes a battery and an external power connector, the method further comprising the step of connecting an external power supply to the external power connector without interrupting a game in progress.

20. The method of claim 14, further comprising the steps of:
establishing a wireless communication link between the keyboard and an external device; and
loading data from the external device into the memory of the keyboard using the wireless communication link.

21. The method of claim 14, further comprising the steps of:
the computer system requesting status information from the keyboard; and
the keyboard responding to this request by transmitting status information to the computer system.

22. The method of claim 14, wherein the computer system includes a display, the method further comprising the step of blanking the display when no response is received from the keyboard in response to communications from the computer system over the wireless communication link.

23. The method of claim 14, wherein the keyboard further includes a unique identifier, the method further comprising the step of the keyboard transmitting the unique identifier with messages sent to the computer system over the wireless communication link.

24. The method of claim 23, wherein the computer system includes memory, the method further comprising the steps of:
storing in computer system memory the unique identifier of a keyboard that initiates a bingo game; and
the computer system ignoring messages during the playing of the bingo game that do not contain the unique identifier stored in memory.

25. A method of supplying game devices for monitoring bingo cards during play, the steps of the method comprising:
providing a plurality of computer systems, each including a wireless transceiver and memory;
loading data into the memories of the computer systems, the data representative of a plurality of bingo cards, including bingo cards in play, a set of games, and a set of winning patterns;
accepting an order from a player specifying a number of bingo cards to be played;
providing a keyboard including memory and a wireless transceiver;
loading data into the keyboard, including an identifier for the number of bingo cards in play; and
initiating a bingo game by communicating between the keyboard and one of the plurality of computer systems using the wireless transceivers.

26. The method of claim 25, the step of loading data into the keyboard comprising the step of inserting a removable key including memory containing the identifier for the number of bingo cards in play.

27. The method of claim 25, wherein the keyboard further includes a battery, the method further comprising the steps of:
monitoring the operational status of the keyboard; and
placing the keyboard into a reduced power mode of operation in response to the monitored status of the keyboard.

28. The method of claim 25, wherein the keyboard further includes a battery and an external power connector, the method further comprising the step of connecting an external power supply to the external power connector without interrupting a game in progress.

29. The method of claim 25, wherein the step of loading data into the keyboard uses the wireless communication link to load the data.

30. The method of claim 25, wherein each of the computer systems further includes a display, the method further comprising the step of blanking the display of a computer system when no response is received from a keyboard in response to communications from the computer system over the wireless communication link.

31. The method of claim 25, wherein the keyboard further includes a unique identifier, the method further comprising the step of the keyboard transmitting the unique identifier with messages sent to any of the plurality of computer systems using the wireless transceiver.

32. The method of claim 31, wherein the step of initiating a bingo game further comprises the step of storing the unique identifier of the keyboard that initiates the bingo game in the memory of the one of the plurality of computer systems, the method further comprising the step of the one of the plurality of computer systems ignoring messages during the playing of the bingo game that do not contain the unique identifier stored in memory.
